(19) United States
(12) Patent Application Publication
(10) Pub. No.: US 2002/0116699 A1
(43) Pub. Date: Aug. 22, 2002

(54) Apparatus and method for checking the status of control systems

(76) Inventors: Armin Amrhein, Kuemmersbruck (DE); Wolfgang Horn, Hohenstein-Ernstthal (DE); Peter Wagner, Hersbruck (DE)

Correspondence Address: BAKER & BOTTS, 30 ROCKEFELLER PLAZA, NEW YORK, NY, 10112

(21) Appl. No.: 10/056,855

(22) Filed: Nov. 13, 2001

(30) Foreign Application Priority Data
Dec. 18, 2000 (DE) 100 630 44.8
May 23, 2001 (DE) 101 253 85.0

(51) Int. Cl. G06F 9/44

(52) U.S. Cl. 717/100

(57) ABSTRACT

An apparatus and method to make debugging of cyclically executed control programs more convenient in a control system. To this end, the control program is compiled into a microprocessor-independent intermediate code. This intermediate code is loaded into the runtime system RS and is compiled there into the microprocessor code. Area details about code areas needing to be examined are stored in a dedicated data storage unit and are mapped onto areas of machine code using debug functionality in the engineering system and in the runtime system.

### FIELD OF THE INVENTION

The present invention relates to an apparatus for assigning parameters to, configuring and starting up control systems and/or creating preferably cyclic control programs with a device for editing a control program, and a compiler device for compiling the control program. The present invention also relates to an apparatus for controlling the timing in a control system on the basis of a control program with a microprocessor device for executing a compiled, preferably cyclic control program. A control system comprising combining the two apparatuses is also described.

### BACKGROUND OF THE INVENTION

In programmable logic controllers, an “engineering system” is often used to debug, assign parameters to and start up a control system, and to create suitable control programs. In addition, a “runtime system” is used to hold the data of the engineering system and to execute the control programs accordingly.

In systems used today, it is virtually impossible, or is possible only with great inconvenience, to debug control programs and to observe control variables. Technologies which are common at present require appropriate hardware support to be set up. This means that, by way of example, debugging is possible only using particular breakpoint mechanisms or interrupts for processors. In controllers operating on an interpretative basis, debugging has to date been possible interpretatively, but this very greatly affects execution time.

Particularly in the case of cyclically executed control programs, it is virtually impossible to observe variables using current means. The user is not able to track the program on the screen at the speed at which a PLC cycle (programmable logic controller) is executed. In addition, observation in the PLC cycle puts a relatively great load on the runtime CPU and would be of little use to the user.

### SUMMARY OF THE INVENTION

With this background, the object of the present invention is to provide an apparatus and a method which can be used to debug and observe system parameters more conveniently during execution of a control program. Accordingly, this object is achieved in an apparatus for assigning parameters to, configuring and starting up control systems and/or for creating preferably cyclic control programs with a device for editing a control program and a compiler device for compiling the control program. The device for editing can be used to mark all or a subarea of the control program for debugging or to instrument the entire control program for debugging. The compiler can be used to produce from the control program an intermediate code which contains debug instrumentation for the marked area of the control program and/or for the entire control program.

The aforementioned object, is further achieved by an apparatus for controlling the timing in a control system on the basis of a control program having a microprocessor for executing a compiled, preferably cyclic control program and a compiler device for compiling a precompiled control program with debug instrumentation into an object code for the microprocessor device.

It is preferred if the intermediate code is independent of one microcontroller type. Further, a data storage device for association information can be provided to associate the marked area of the control program with an instruction of the intermediate code. In addition, the editor device can contain an order unit for dispatching an observation order for the marked area. Accordingly, the editor device can comprise a reception device for receiving observation information.

The apparatus for controlling the timing in a control system on the basis of a control program can be equipped with an observation module which can be set up using the debug instrumentation. In addition, a data buffer device can be provided to store and provide observation information from the observation module. The apparatus can then use a reception device to receive an execution order for the observation module.

A control system comprising both of the aforementioned apparatuses has been found to be particularly preferred for controlling a system.

### BRIEF DESCRIPTION OF THE DRAWINGS

The present invention is explained in more detail below in connection with an exemplary embodiment and with reference to the drawings, in which:

FIG. 1 shows a data flowchart for an inventive arrangement; and

FIG. 2 shows a data flowchart for a status query.

### DETAILED DESCRIPTION OF THE INVENTION

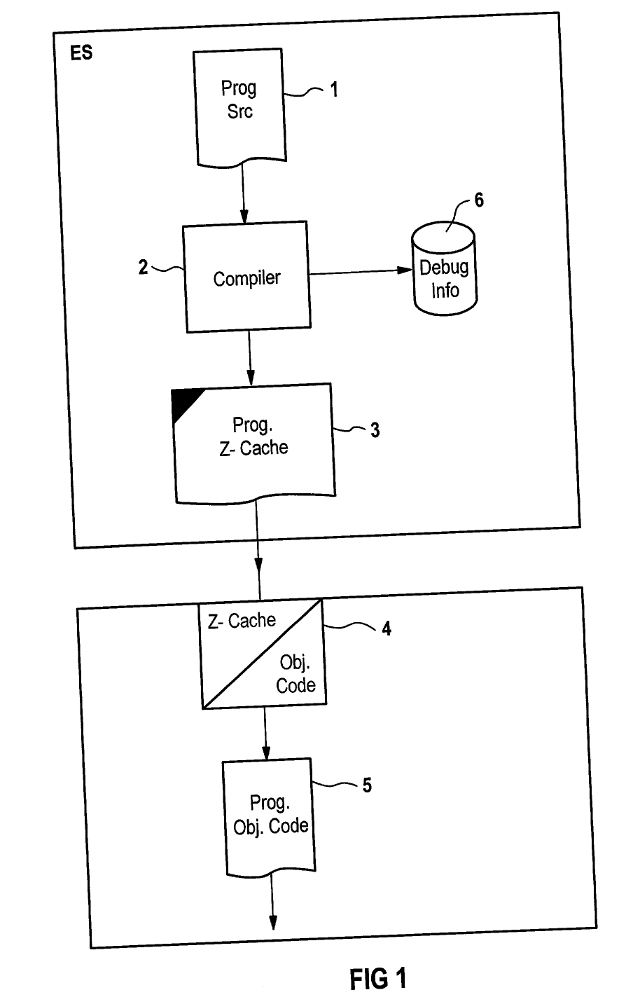

FIG. 1 show a control program 1, for example in structured text format, is stored in the engineering system ES. A compiler 2 produces a specifically instrumented intermediate code 3 for the control program 1. This intermediate code 3 contains additional information which a runtime system RS subsequently uses to permit status queries about appropriate variables. The compiler 2 compiles the control program before it is downloaded into the runtime system RS. The runtime system RS or the controller uses a further compiler 4 to convert this intermediate code 3 into a microprocessor-specific code 5.

The compiler functionality for converting the source code of the control program 1 into a machine-independent intermediate code is implemented in the basic engineering system ES. The basic engineering system ES has a specific data storage unit 6 for debugging or association information. This association information indicates which control program lines correspond to which intermediate code sections.

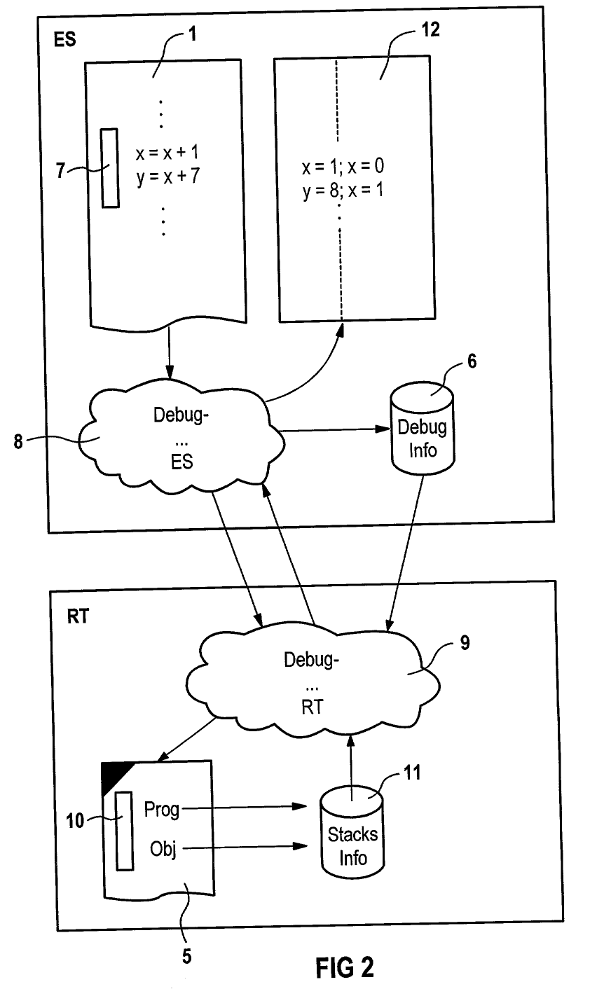

FIG. 2 illustrates that a user can use graphical markers 7 to identify sections of control program lines. On the basis of this, a debugger 8 in the engineering system ascertains the associated intermediate code area, and the appropriate area details are stored in the data storage unit 6. The association can be made using an association table or a reference, for example.

The engineering system thus contains a control program 1 with a compiled intermediate code 3. This intermediate code 3, which is instrumented, is then loaded into the runtime system RS. The runtime system RS does not just convert the intermediate code 3 into the microprocessor code 5, but also has a dedicated debug functionality 9 which is used to ascertain, and, if appropriate, to observe, the area 10 of the microprocessor code 5 on the basis of the intermediate code section corresponding to the marked area of the control program in a data storage unit (not shown).

The control program can now be executed, i.e. the CPU of the runtime system RS can go to run mode. The microprocessor code is processed cyclically. Since the user has marked a particular area in the control program, an order to the runtime system RS is generated regarding which intermediate code area needs to be observed. The runtime system RS ascertains the microprocessor code areas from this information and sets up the infrastructure for program observation. This means that special buffers are prepared to buffer-store status information. When this service has been set up, it is available for use by the user.

If the program observation function is now explicitly initiated by the user, e.g. in the editor, an observation module is set up in the runtime system RS. When the program enters one of these machine code areas corresponding to the marked area of the control program, the variable values in question are written to appropriate data buffers 11. This is done so long as the program is in these specific code areas.

When the scope of the code area is left, the engineering system ES receives a notification from this observation module. The engineering system fetches the information from the data buffer 11. The debug module 8 in the engineering system ES ascertains the relevant line information for the control program from the intermediate code association and this data buffer 11. The variables required by the user can then be displayed. Once they have been displayed, a new observation order for this infrastructure which has been set up can be placed as desired. This means that the observation or debug cycle or the flow control is actually performed using the editor. This is useful to the extent that the user can track the program on the screen out of time with the PLC cycle. In addition, observation in the PLC cycle would put an excessive load on the runtime CPU. The data of the requested variables are thus updated only on explicit request or, by way of example, cyclically every second.

If the user activates the debug mechanism 8 in the engineering system ES, the values of the variables used in the program code are displayed to him consistently for the respective pass in a second window 12 next to his control program source 1 for the program code executed on an appropriate cyclic basis. The user can thus conveniently perform diagnosis and a program debug within the context of cyclic PLC functionality. For performance reasons, an interpretative solution is less advantageous for implementing the mechanism.

The advantage of the present invention is thus that debugging or observation of variables is performed independently of hardware. In addition, the inventive technique loads the CPU of the runtime system only to the extent that the program editor can utilize this observation. This means that the program execution time is slowed down at most by the observation of the marked area. The reason for this is that the debug code is processed only for the marked area of the control program. All other areas are executed without a debug option.

As already indicated, the inventive functionality and this mechanism of selective debugging are best suited to debugging cyclically executed programs. However, motion tasks, which are not executed cyclically, can also be observed very well. In particular, an additional mechanism allows the trace buffer 11 to be fetched before the scope is actually left. This makes it possible to ascertain, for example, when and with which parameters synchronous calls are encountered. The method outlined and the associated mechanism are also suitable for finding deadlocks in motion tasks.

We claim:

1. An apparatus for assigning parameters to, configuring and starting up a control system and for creating a control program comprising a device for editing a control program, and device for compiling the control program, wherein the editing device is used to mark an area of the control program for debugging, and the compiling device is used to produce from the control program an intermediate code which contains debug instrumentation for the marked area of the control program.

2. The apparatus according to claim 1, wherein the intermediate code is microprocessor-independent.

3. The apparatus according to claim 1, further comprising a data storage device for association information for associating the marked area of the control program with an area of the intermediate code.

4. The apparatus according to claim 1, wherein the editing device comprises an order unit for dispatching an observation order for the marked area.

5. The apparatus according to claim 1, wherein the editing device further comprises a reception device for receiving observation information.

6. An apparatus for controlling the timing in a control system control program comprising a microprocessor for executing a compiled control program, a device for compiling a precompiled control program having debug instrumentation into an object code for the microprocessor.

7. The apparatus according to claim 6, further comprising an observation module using the debug instrumentation.

8. The apparatus according to claim 7, further comprising a data buffer for storing and providing observation information from the observation module.

9. The apparatus according to claim 7, further comprising device for receiving an execution order for the observation module.

10. A control system comprising an apparatus according to claim 1 and an apparatus according to claim 6, wherein the intermediate code corresponds to the precompiled control program.

11. A method for assigning parameters to, configuring and starting up a control system and for creating a control program comprising editing a control program, compiling the control program, marking an area of the control program for debugging during editing, and producing an intermediate code from the control program during compiling, said intermediate code containing debug instrumentation for the marked area of the control program.

12. The method according to claim 11, wherein the intermediate code is microprocessor-independent.

13. The method according to claim 11, wherein the marked area of the control program is associated with an area of the intermediate code.

14. The method according to claim 11, further comprising dispatching an observation order for observing the marked area during editing.

15. The method according to claim 14, wherein observation information is received during editing.

16. A method for controlling the timing in a control system on the basis of a control program comprising executing a compiled control program, by compilation of a precompiled control program having debug instrumentation into an object code for a microprocessor.

17. The method according to claim 16, further comprising setting up an observation module using the debug instrumentation.

18. The method according to claim 17, further comprising storing and providing information from the observation module in a data buffer device.

19. The method according to claim 17, further comprising receiving and carrying out an execution order for the observation module during execution of the control program.

20. A method for controlling a control system comprising the method according to claim 11 and the method according to claim 16, wherein the intermediate code corresponds to the precompiled control program.

21. An apparatus according to claim 1, wherein the control program is a cyclic control program.

22. An apparatus according to claim 6, wherein the compiled control program is a compiled cyclic control program.

23. A control system according to claim 10, wherein the control program is a cyclic control program.

24. A method according to claim 11, wherein the control program is a cyclic control program.

25. A method according to claim 16, wherein the compiled control program is a compiled cyclic control program.

26. A method according to claim 20, wherein the control program is a cyclic control program.
